(19) United States
(12) Patent Application Publication
(10) Pub. No.: US 2007/0179681 A1
(43) Pub. Date: Aug. 2, 2007

(54) SYSTEM AND METHOD FOR OPERATING A VEHICLE

(75) Inventors: Aric Shaffer, Ypsilanti, MI (US); Ronald Miller, Saline, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/275,837

(22) Filed: Jan. 31, 2006

(51) Int. Cl. G06F 17/00

(52) U.S. Cl. 701/1

(57) ABSTRACT

A system and method for identifying and communicating a road condition includes a first vehicle having at least one sensor integrated therewith. The sensor is configured to sense the road condition and wirelessly transmit signals pertaining to the road condition and a geographic location of the road condition. A receiver device is included for receiving the signals pertaining to the road condition.

### TECHNICAL FIELD

The present invention relates generally to a system and method for controlling the operation of a vehicle and in particular to a system and method for controlling the operation of a vehicle in response to data transmitted by other vehicles.

### BACKGROUND

Hybrid electric vehicles include an internal combustion engine (ICE) and a motor which are both configured to provide motive force to the vehicle. In certain hybrid vehicles, the motor is configured to charge a battery during predetermined vehicle operations. For example, as the hybrid electric vehicle decelerates, the motor is configured to operate as a generator and charge the battery which is coupled thereto. Recently, designers have developed methods for predicting a vehicle's operating status to maintain adequate state of charge for the battery. In such systems, the ICE is turned off or disengaged when the vehicle traverses a particular topography. Such functionality is enabled by a navigation system that is operable with the charging system of the hybrid electric vehicle. Based on information received from the navigation system, the vehicle is configured to control charging and/or discharging of the battery to optimize the state of charge of the battery. Although these systems have shown some improvement, these systems are expensive to implement and maintain.

Additionally, other disadvantages of conventional hybrid electric vehicles include the lack of control of compression braking. It is recognized that the motor of the hybrid electric vehicle is configured to apply compression braking to the vehicle which has been known to cause a wheel slip or a wheel lock up event on low friction surfaces (e.g., ice). To reduce the occurrence of a wheel slip or wheel lockup event, HEV systems have been designed to disengage any applied regenerative braking. However, it is known that the reduction in regenerative braking may result in a lunge-forward feeling to a vehicle occupant or driver which is undesirable to the occupant.

Thus, there exists a need for a system that is configured to utilize navigational data for controlling the HEV in an efficient and cost-effective manner.

### SUMMARY OF THE INVENTION

The present invention discloses a system for identifying and communicating a road condition. The system includes a first vehicle having at least one sensor integrated therewith. The sensor is configured to sense the road condition and wirelessly transmit signals pertaining to the road condition and a geographic location of the road condition. A receiver device is included for receiving the signals pertaining to the road condition.

The method includes sensing a road condition through the use of at least one sensor integrated with a first vehicle. Accordingly, the sensor is configured to generate signals that correspond to the road condition and a geographic location of the road condition. The method further includes transmitting the signals that correspond to the road condition and the geographic location. The method also includes receiving the signals and generating corresponding signals through the use of a receiver device.

### BRIEF DESCRIPTION OF THE DRAWINGS

The features of the present invention which are believed to be novel are set forth with particularity in the appended claims. The present invention both as to its organization and manner of operation, together with further objects and advantages thereof, may be best understood with reference to the following description, taken in connection with the accompanying drawings in which:

FIGS. 1A and 1B illustrate a vehicle notification system for identifying and communicating a road condition in accordance with embodiments of the present invention; and

FIGS. 2 and 3 illustrate detailed system diagrams of vehicles that are operable with the vehicle notification system of FIG. 1.

### DETAILED DESCRIPTION OF THE PREFERRED EMBODIMENT(S)

By way of example, a system and methodology for implementing the present invention is described below. The provided system and methodology may be adapted, modified or rearranged to best-fit a particular implementation without departing from the scope of the present invention.

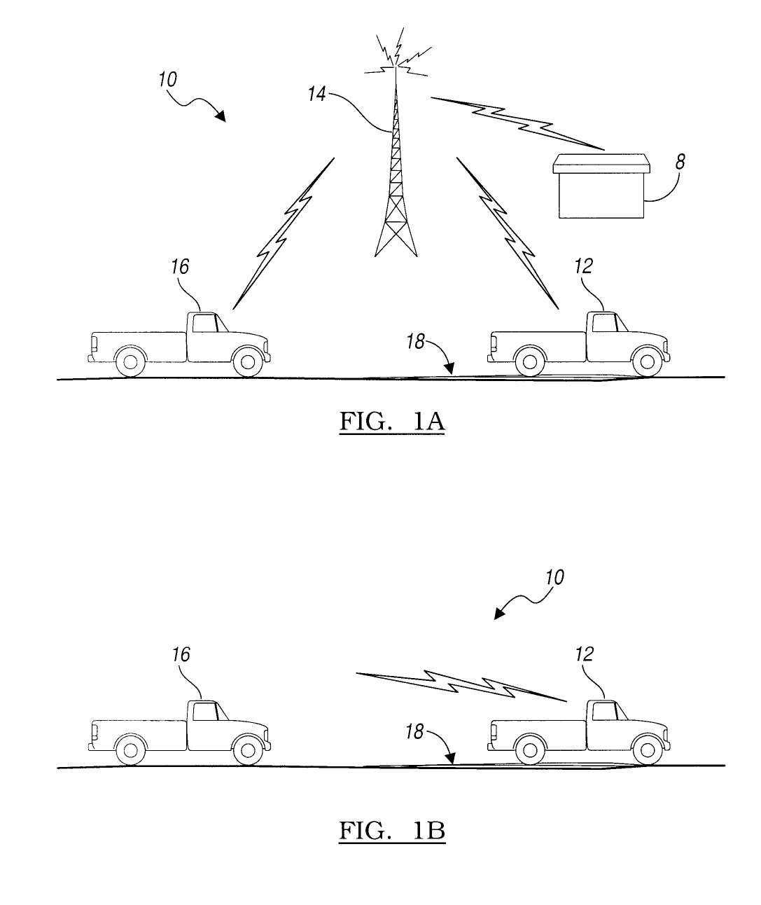

Referring to FIGS. 1A and 1B, a vehicle notification system 10 is illustrated for detecting and communicating a road condition. Particularly as shown in FIG. 1A, vehicle notification system 10 includes a first vehicle 12, a land-based communications device 14, and a second vehicle 16. Vehicle 12 is configured to detect a road condition 18 such as ice, oil, etc., and transmit signals pertaining to road condition 18 to vehicle 16. Additionally, vehicle 12 includes a system of sensors (e.g., anti-lock braking system sensors) that are capable of detecting road condition 18 as vehicle 12 traverses road condition 18. Accordingly, upon detection of road condition 18, vehicle 12, which has a transceiver that communicates with the vehicle sensors, transmits signals that indicate the geographic location of road condition 18. In one aspect, the signals generated by vehicle 12 may provide latitude and longitude coordinates pertaining to the specific area or location in which road condition 18 is located.

In yet another embodiment, the signals transmitted from vehicle 12 may be initially received by land-based communications device 14, which is adapted to retransmit the signals to vehicle 16. Land-based communications device 14 may include an antenna and a transceiver (i.e., receiver and transmitter) capable of wirelessly receiving data from a travel advisory system (e.g., traffic advisory station 13) and transmitting this data to other vehicles (e.g., vehicle 16). Traffic advisory station 8 may include a database for the entry and processing of traffic and road related data. Accordingly, traffic advisory station 8 may serve as a location from which traffic and road conditions are transmitted to land-based communications device 14. As shown in FIG. 1B, land-based communications device 14 may be excluded in some embodiments. As such, the signals generated by vehicle 12 may be transmitted directly to vehicle 16.

Specifically, regarding vehicle 16, vehicle 16 includes a receiver/navigation unit for receiving the signals transmitted by either vehicle 12 and/or land-based communications device 14. In one embodiment, vehicle 16 may be a hybrid-electric vehicle having an internal combustion engine, a motor, and a generator. In yet another embodiment, vehicle 16 may be full-cell type vehicle without departing from the scope of the present invention. As will be described in more detail hereinafter, the generator and/or motor are also capable of generating a regenerative braking torque. Additionally, the generator, motor, and internal combustion engine of vehicle 16 are responsive to the signals transmitted by vehicle 12. Particularly, the receiver of vehicle 16 communicates with a controller located on vehicle 16 that enables automatic adjustment of the internal combustion engine, generator, and motor.

Now, a non-limiting example of the detection and communication of a road condition by vehicle notification system 10 will be provided. In one aspect of the present invention, vehicle 12 may detect road condition 18 (such as an ice patch, oil and the like) through the use of an ABS system. Consequently, the transceiver of vehicle 12 transmits signals indicative of road condition 18 to vehicle 16 directly or via land-based communications device 14. In response to the signals received, the receiver unit of vehicle 16 generates signals for a controller located on vehicle 16. The controller is configured to process the received signals and generate control signals that control the operation of powertrain components including the internal combustion engine, the generator and/or motor of vehicle 16. As such, depending upon the controller's processing of the received signals, the output of the internal combustion engine and/or the braking torque generated by the generator and/or motor may be adjusted as vehicle 16 approaches or is at road condition or geographic location 18. Furthermore, adjustment of the braking torque alleviates the “lunge forward” feeling experienced by vehicle occupants when the ABS system is activated on HEV type vehicles. Also, adjustment of the internal combustion engine, the generator, and/or the motor, optimizes fuel efficiency and vehicle emissions. It is recognized that although the embodiments shown in FIGS. 1A and 1B illustrate a single vehicle for receiving the road condition signals, vehicle 16 is merely exemplary of any number of vehicles that are adapted to receive and respond to signals generated by the vehicle 12.

In other embodiments, the vehicle 16 may receive data pertaining to traffic conditions including, but not limited to traffic congestion, the status of traffic lights at intersections, the topography of a road, and the like. Accordingly, based on the received data vehicle 16 is configured to automatically adjust the internal combustion engine output and generator and/or motor output to optimize fuel efficiency and vehicle emissions. Furthermore, the automatic adjustment of the powertrain devices, enables charging or discharging of a battery located on vehicle 16, thereby optimizing the battery's state of charge.

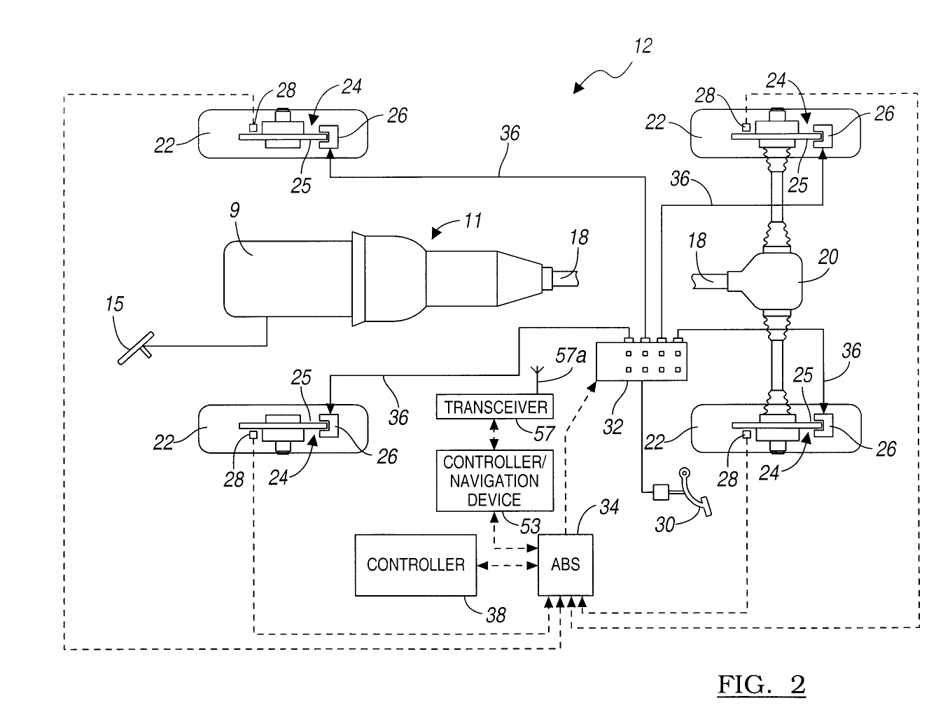

Now referring specifically to FIG. 2, a detailed diagram of vehicle 12 is illustrated. Vehicle 12 includes a powertrain having an engine 9, a transmission 11 and a drive shaft 18. As recognized by one of ordinary skill in the art, engine 9 responds to a vehicle operator request to decelerate or accelerate vehicle 12 through the use of an accelerator pedal 15. Additionally, alternative embodiments of vehicle 12 may include fuel-cell type vehicles.

Drive shaft 18 mechanically couples transmission 11 to a differential 20. Differential 20 is mechanically coupled to wheels 22 thereby enabling movement of vehicle 12 in response to motive force from engine 9. As shown, vehicle 12 further includes friction brakes 24. Brakes 24 include a brake disc 25, a caliper 26, and a speed sensor 28 that communicates with an anti-lock braking system (ABS) module 34. Caliper 26 is operable with brake disc 25 for slowing and/or stopping vehicle 12. ABS module 34 is operable with a pressure adjustment unit 32. In response to a brake request from a brake pedal 30, pressure adjustment unit 32 is configured to enable proper distribution of braking fluid to brakes 24 through the use of liquid pressure passages 36. Although the embodiment shown in FIG. 2 illustrates a braking system that utilizes hydraulics, it is recognized that the friction braking system of FIG. 1 may be a pure brake-by-wire (BBW) system, an electromechanical braking system or a hydro-mechanical braking system without departing from the scope of the present invention.

As shown by FIG. 2, vehicle 12 also includes a controller/navigation device 53 and a transceiver 57. The controller/navigation device 53, which communicates with the transceiver 57, has data processing capabilities that enable vehicle 12 to determine the location of a road condition and transmit signals pertaining to the road condition. As such, ABS module 34 is configured to generate signals for controller 53 and transceiver 57. In one aspect of the invention, the road condition may be sensed via activation of the ABS. Accordingly, when vehicle 12 senses a road condition via ABS module 34, ABS module 34 sends corresponding signals to the controller/navigation device 53 which processes the signal and identifies the specific location of the road condition. As described above, controller/navigation device 53 may identify the location of the road condition by latitude and longitude coordinates. The processed signals are then received by transceiver 57. Transceiver 57 transmits the signals to other vehicles (e.g., vehicle 16) through the use of a transceiver antenna 57a. Additionally, vehicle 12 is also configured to receive road condition information from other devices (e.g., traffic advisory station 8) or vehicles via transceiver 57 and transmit the information to other vehicles. Furthermore, it is recognized that vehicle 12 may be embodied as an HEV or any type of vehicle capable of detecting a road condition and transmitting corresponding signals pertaining to the road condition.

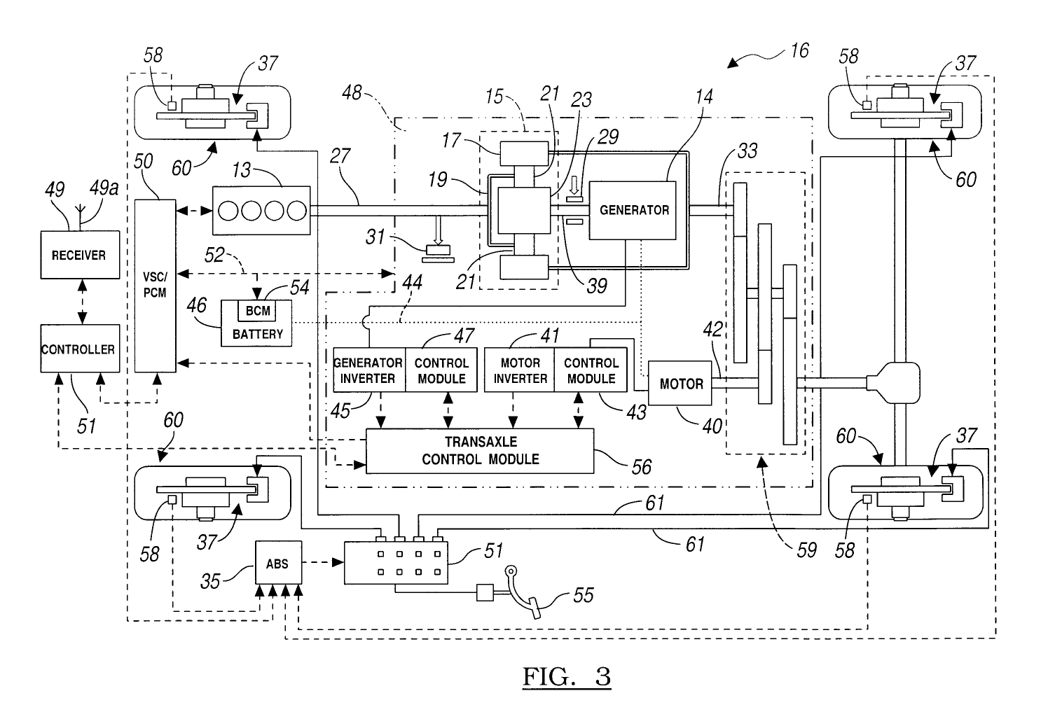

Now, referring to FIG. 3, a detailed illustration of vehicle 16 is provided. It is recognized that vehicle 16, although shown as an HEV, may be any type of vehicle capable of automatic powertrain adjustments in response to the transmitted signals. Accordingly, vehicle 16 includes an internal combustion engine (ICE) 13 and an electric machine, or generator 14. The ICE 13 and the generator 14 are connected through a power transfer unit, which in this embodiment is a planetary gear set 15. Of course, other types of power transfer units, including other gear sets and transmissions, may be used to connect the ICE 13 to the generator 14. The planetary gear set 15 includes a ring gear 17, a carrier 19, planet gears 21, and a sun gear 23.

The generator 14 can also be used as a motor, outputting torque to a shaft 39 connected to the sun gear 23. Similarly, the ICE 13 outputs torque to a shaft 27 connected to the carrier 19.

A brake 29 may be, but not necessarily, provided for stopping rotation of the shaft 39, thereby locking the sun gear 23 in place. Because this configuration allows torque to be transferred from the generator 14 to the ICE 13, a one-way clutch 31 may be, but not necessarily, provided so that the shaft 27 rotates in only one direction. Having the generator 14 operatively connected to the ICE 13, as shown in FIG. 3, allows the speed of the ICE 13 to be controlled by the generator 14.

The ring gear 17 is connected to a shaft 33, which is connected to vehicle drive wheels 60 through a second gear set 59. Vehicle 16 includes a second electric machine, or motor 40, which can be used to output torque to a shaft 42. Other vehicles within the scope of the present invention may have different electric machine arrangements, such as more or less than two electric machines. In the embodiment shown in FIG. 3, the motor 40 and the generator 14 can both be used as motors to output regenerative braking torque. Alternatively, each can also be used as a generator, outputting electrical power to a high voltage bus 44 and to an energy storage device, or battery 46.

The battery 46 is a high voltage battery that is capable of outputting electrical power to operate the motor 40 and the generator 14. Other types of energy storage devices and/or output devices can be used with a vehicle, such as the vehicle 16. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 16. As described above, the state of charge of battery 46 may be optimized by automatic adjustment of motor 40 and generator 14.

As shown in FIG. 3, the motor 40, the generator 14, the planetary gear set 15, and a portion of the second gear set 59 may generally be referred to as a transaxle 48. The transaxle 48 is analogous to a transmission in a conventional vehicle. Thus, when a driver selects a particular gear, the transaxle 48 is appropriately controlled to provide that gear. To control the ICE 13 and the components of the transaxle 48—e.g., the generator 14 and motor 40—a control system, including a first controller 50, is provided. As shown in FIG. 3, the controller 50 is a combination vehicle system controller and powertrain control module (VSC/PCM). Although it is shown as a single hardware device, it may include multiple controllers in the form of multiple hardware devices, or multiple software controllers within one or more hardware devices.

A controller area network (CAN) 52 allows the controller 50 to communicate with the transaxle 48 and a battery control mode (BCM) 54. Just as the battery 46 has the BCM 54, other devices controlled by the controller 50 may have their own controllers. For example, an engine control unit (ECU) may communicate with the controller 50 and may perform control functions on the ICE 13. In addition, the transaxle 48 may include one or more controllers, such as a transaxle control module (TCM)56, configured to control specific components within the transaxle 48, such as the generator 14 and/or the motor 40. Accordingly, as shown in FIG. 3, the TCM 56 communicates with a generator inverter 45 and a motor inverter 41. In one embodiment, the generator inverter 45 and the motor inverter 41 are each coupled to a control module 47 and a control module 43, respectively. Control modules 43 and 47 are capable of converting raw vehicle sensor data readings to a format compatible with the TCM 56 and sending those readings to the TCM 56.

As shown, vehicle 16 further includes friction brakes 37. Brakes 37 include a brake discs, a caliper 37b, and a speed sensor 58 that communicates with an anti-lock braking system (ABS) module 35. Caliper 37bis operable with the brake discs for slowing and/or stopping vehicle 16. ABS module 35 is also operable with a pressure adjustment unit 51. In response to a brake request from a brake pedal 55, pressure adjustment unit 51 is configured to enable proper distribution of braking fluid to brakes 37 through the use of liquid pressure passages 61. Although the embodiment shown in FIG. 3 illustrates a braking system that utilizes hydraulics, it is recognized that the friction braking system of FIG. 3 may be a pure brake-by-wire (BBW) system, an electromechanical braking system or a hydro-mechanical braking system without departing from the scope of the present invention.

Furthermore, as illustrated by FIG. 3, vehicle 16 includes a receiver 49 having a receiver antenna 49a. The signals received by receiver 49 are sent to a controller 51 for processing. Controller 51 is configured to determine the location of the road condition based on the signals received by receiver 49. As such, when the location of the road condition is determined, controller 51 generates signals for TCM 56. In response, TCM 56 generates signals for generator 14 and motor 50 that cause automatic adjustment of the braking torque produced as vehicle 16 approaches the road condition. Accordingly, the appropriate amount of torque is supplied to vehicle 16, which improves vehicle stability and control when traversing the road condition. Such automatic adjustments also enables optimized charging or discharging of the battery 46, which enhances the battery 46 state of charge. In some embodiments, optimized charging or discharging of the battery 46 is enabled by transmitting data related to the latitude, longitude, and/or height of the road condition. Accordingly, the vehicle may decrease engine output and utilize battery power while climbing hills. Conversely the engine output may be decreased as the vehicle descents. As such, friction brake pad wear and engine wear is reduced while fuel economy is increased.

Additionally, the adjustment of torque output alleviates the “lunge forward” feeling experienced by vehicle occupants when the ABS system detects the road condition. Also, the controller 51 communicates with controller 50 as illustrated in FIG. 3. As such, the signals received by the receiver may be processed by controllers 51 and 50 and cause automatic adjustment of the ICE 13. Adjustment of the ICE 13 improves vehicle emissions and fuel savings.

Although the vehicle 16, shown in FIG. 3, is an HEV, it is understood that the present invention contemplates the use of other types of vehicles. In addition, although the vehicle 16 shown in FIG. 3 is a parallel-series HEVs, the present invention is not limited to HEV's having such a “powersplit” configuration. Furthermore, although the vehicle 16 is illustrated having a single motor (i.e., motor 40), other embodiments may include additional motors without departing from the scope of the present invention.

While the best mode for carrying out the invention has been described in detail, those familiar with the art to which this invention relates will recognize various alternative designs and embodiments for practicing the invention as defined by the following claims.

What is claimed:

1. A system for identifying and communicating a road condition, comprising:
a vehicle having at least one sensor integrated therewith, the sensor being configured to sense the road condition and wirelessly transmit signals pertaining to the road condition and a geographic location of the road condition; and
a receiver device for receiving the signals pertaining to the road condition.

2. A system according to claim 1, further comprising:
a land-based communications device in which the receiver device is integrated therewith; and
a second vehicle having a motor and an internal combustion engine (ICE) that is adapted to receive signals from the land-based communications device having the receiver device integrated therewith, the receiver device being configured to generate signals that cause automatic adjustment of the ICE output, wherein the automatic adjustment of the ICE output occurs as the second vehicle approaches or is within the geographic location of the road condition.

3. A system according to claim 1, further comprising a second vehicle having a motor and/or generator, an internal combustion engine (ICE), and the receiver device integrated therewith, the receiver device being configured to generate signals that cause automatic adjustment of the ICE output, wherein the automatic adjustment of the ICE output occurs as the second vehicle approaches the geographic location of the road condition.

4. A system according to claim 3, wherein the second vehicle being operable with the receiver device includes a battery that is coupled to the motor, wherein the signals generated by the receiver device cause charging or discharging of the battery.

5. A system according to claim 3, wherein the receiver device being operable with the second vehicle is configured to generate signals that cause automatic adjustment of the motor and/or generator output.

6. A system according to claim 5, wherein automatic adjustment of the motor and/or generator output occurs as the second vehicle approaches the geographic location of the road condition.

7. A system according to claim 6, wherein automatic adjustment of the motor and/or generator output includes reducing the generation of regenerative braking torque produced by the motor and/or generator.

8. A system according to claim 1, wherein the sensor includes an anti-lock braking system (ABS) that communicates with a navigation device and the signals transmitted by the sensor that pertain to the geographic location of the road condition further comprise signals that indicate the latitude and longitude in which the road condition is located.

9. A method for identifying and communicating a road condition, comprising:
sensing a road condition through the use of at least one sensor integrated with a first vehicle, the sensor being configured to generate signals that correspond to the road condition and a geographic location of the road condition;
transmitting the signals that correspond to the road condition and the geographic location; and
receiving the signals through the use of a receiver device.

10. A method according to claim 9, further comprising:
configuring a land-based communications device to have the receiver device integrated therewith; and
configuring a second vehicle to have a motor and an internal combustion engine (ICE) that is adapted to receive signals from the land-based communications device, the receiver device being configured to generate signals that cause automatic adjustment of the ICE output, wherein the automatic adjustment of the ICE output occurs as the second vehicle approaches or is within the geographic location of the road condition.

11. A method according to claim 9, further comprising:
integrating the receiver device with a second vehicle having a motor and/or a generator and an internal combustion engine (ICE), the receiver device being configured to generate signals that cause automatic adjustment of the ICE output, wherein the automatic adjustment of the ICE output occurs as the second vehicle approaches the geographic location of the road condition.

12. A method according to claim 11, wherein the second vehicle includes a battery that is coupled to the motor and the signals generated by the receiver device cause charging or discharging of the battery.

13. A method according to claim 11, wherein the receiver device being integrated with the second vehicle is configured to generate signals that cause automatic adjustment of the motor and/or generator output.

14. A method according to claim 13, wherein automatic adjustment of the motor and/or generator output occurs as the second vehicle approaches the geographic location of the road condition.

15. A method according to claim 14, wherein automatic adjustment of the motor and/or generator output includes reducing the generation of regenerative braking torque produced by the motor and/or generator.

16. A method according to claim 9, wherein sensing the road condition through the use of at least one sensor integrated with the first vehicle includes sensing the road condition through the use of an anti-lock braking system (ABS).

17. A system for assessing and communicating a road condition, comprising:
a first vehicle having at least one sensor integrated therewith, the sensor being configured to sense the road condition and wirelessly transmit signals pertaining to the road condition and a geographic location of the road condition;
a receiver device for receiving the signals pertaining to the road condition, the receiver device being configured to generate signals in response to the received signals;
a second hybrid-electric vehicle (HEV) having an anti-lock braking system (ABS), and a motor and/or generator being adapted to generate regenerative braking torque, the second vehicle being configured to receive the signals generated by the receiver device and automatically adjust an output of the motor and/or generator; and
wherein the automatic adjustment of the motor and/or generator output reduces an amount of regenerative braking torque and the automatic adjustment occurs as the second vehicle approaches the road condition wherein the ABS provides a substantial amount of braking force for the second vehicle.

18. A system according to claim 17, wherein the second vehicle includes an internal combustion engine (ICE), the second vehicle being configured to automatically reduce the ICE output in response to signals generated by the receiver device.

19. A system according to claim 17, further comprising:
a land-based communications device configured to receive the signals generated by the sensor prior to receipt of the signals by the second vehicle, the land-based communications device transmitting the signals to the second vehicle.

20. A system according to claim 18, wherein the land-based communications device is operable with a travel advisory system.
